(19) United States
(12) Patent Application Publication
(10) Pub. No.: US 2004/0090515 A1
(43) Pub. Date: May 13, 2004

(54) Print head and image forming apparatus

(76) Inventors: Nobuhito Matsushiro, Tokyo (JP); Kazuyo Watanabe, Tokyo (JP)

Correspondence Address: KANESAKA & TAKEUCHI, 1423 Powhatan Street, Alexandria, VA, 22314, US

(21) Appl. No.: 10/648,383

(22) Filed: Aug. 27, 2003

(30) Foreign Application Priority Data
Aug. 28, 2002 (JP) 2002-248502

(51) Int. Cl. B41J 2/385

(52) U.S. Cl. 347/130

(57) ABSTRACT

A print head comprises a plurality of light emitting devices which are arranged such that the adjacent light emitting devices are stepped from each other in the rotation direction of a photosensitive member, or a plurality of light emitting devices which are disposed linearly such that the light emitting devices emit light at different timings each other by employing a delay mechanism. Consequently, it is possible to provide the output pattern capable of directing the human eyes in two dimensions so as to reduce the visible difference in the image density.

### BACKGROUND OF THE INVENTION

1. Field of the Invention

The present invention relates to an image forming apparatus, such as an copying machine, printer, and facsimile machine, using a print head including a plurality of light emitting devices, and a print head used in such an apparatus.

2. Description of the Related Art

The image forming apparatus, such as a printer, using the electro-photographic system comprises an exposing device for exposing a photo-sensitive member by a light source, such as an LED, to form on the photo-sensitive member an electrostatic latent image which is to be developed.

FIG. 7 shows an LED head containing an LED array chip for an exposing device used in a conventional image forming apparatus. In an example of FIG. 7, a plurality of LEDs 1a linearly arranged in a longitudinal direction of a rectangular LED array chip 1. This array chip produces a linear output pattern in a main scanning direction. It has six hundreds of LEDs 1a arranged per inch for the image forming apparatus having a resolution of 600 dpi.

The LEDs 1a of the LED array chip 1 have different luminous strengths because of ununiformity of characteristics caused by the manufacturing tolerance. The different luminous strengths can cause ununiform image density, resulting in the poor print quality.

FIG. 8 shows an output pattern of image simulation of a conventional image forming apparatus. In an example of FIG. 8, there is a significant difference in the size of dots between the third and fourth columns of dots from the right of the drawing in each dot row extending in a horizontal direction corresponding to the respective LEDs 1a. The difference of the dot size is caused by different luminous energies of the respective LEDs 1a. This difference in the third and fourth columns of dots produces a belt pattern around the fourth column, which has a density lower than that of the periphery thereof because of the relatively low ratio of black area per unit area. This belt pattern is caused by the different image density and readily recognized by the eyes as a pattern having a strong directivity.

### SUMMARY OF THE INVENTION

Accordingly, it is an object of the present invention to provide an image forming apparatus which reduces the difference in the image density that is easily visible.

A print head according to the invention comprises a plurality of light emitting devices disposed at such positions as to make exposure at substantially equal intervals in a main scanning direction and adjacent devices of the light emitting devices are disposed in a stepped-fashion in a sub-scanning direction perpendicular to the main scanning direction.

The extent of the stepped-fashion may be determined such that the stepped-fashion provides spatial frequency characteristics exceeding a specific spatial frequency, wherein the spatial frequency characteristics may be determined by distances in the main scanning direction between one of the light emitting device and the others of the light emitting devices and positioning differences in the sub-scanning direction between the one of the light emitting devices and the others of the light emitting devices.

The spatial frequency characteristics may have a predetermined frequency band width. The spatial frequency characteristics may have characteristics of a blue noise.

The spatial frequency characteristics may have characteristics of line spectrum noises indicating specific spatial frequencies.

An image forming apparatus according to the invention comprises a photosensitive member and a print head including a plurality of light emitting devices for emitting light to the photosensitive member so as to form an electrostatic latent image on the photosensitive member in a main scanning direction. Each of the light emitting devices is arranged in a stepped-fashion with respect to each other in a sub-scanning direction perpendicular to the main scanning direction.

### BRIEF DESCRIPTION OF THE DRAWINGS

FIG. 1 is a schematic diagram of an image forming apparatus according to the present invention.

FIG. 2 is an exploded perspective view of a print head according to the first embodiment of the invention.

FIG. 3 is a schematic diagram of an LED arrangement according to the first embodiment.

FIG. 4 is a schematic diagram showing characteristics of the LED arrangement according to the first embodiment.

FIGS. 5(a) and 5(b) are graphs showing frequency characteristics of the LED arrangement according to the first embodiment.

FIG. 6 is a schematic diagram showing an output pattern of the image forming apparatus according to the first embodiment.

FIG. 7 is a schematic diagram of an LED arrangement according to the prior art.

FIG. 8 is a schematic diagram of the output pattern of an image forming apparatus according to the prior art.

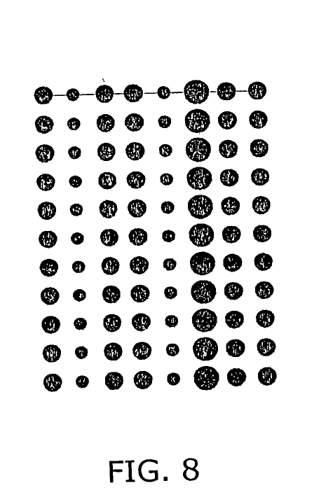

FIG. 9 is a block diagram of a drive circuit according to the second embodiment of the invention.

### DESCRIPTION OF THE PREFERRED EMBODIMENT

(First Embodiment)

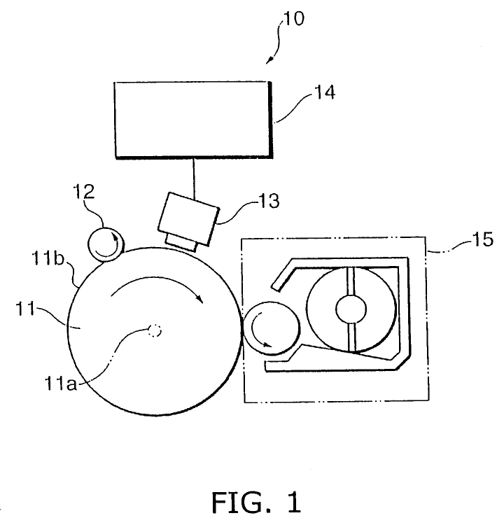

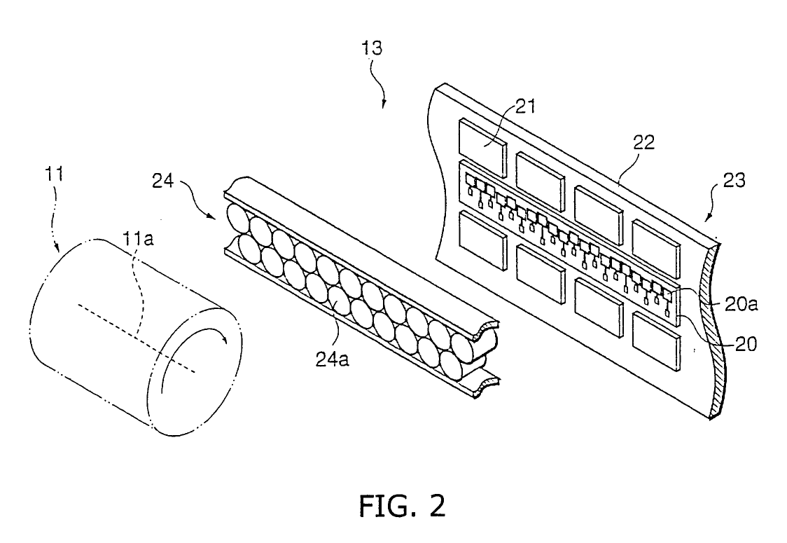

In FIG. 1, an image forming apparatus 10 according to the first embodiment comprises a cylindrical photo-sensitive member 11 rotatable about a rotation axis 11a in a predetermined direction, a charging device 12 for charging a side surface 11b of the photo-sensitive member 11 in a main scanning direction in parallel to the rotation axis 11a, a print head 13 for emitting exposure light to the photo-sensitive member 11 so as to form electrostatic latent image on the side surface 11b of the photo-sensitive member 11, a drive circuit 14 to control a driver chip 21 (FIG. 2) of the print head 13, and a development device 15 for supplying toner to develop the electrostatic image formed on the photo-sensitive member 11.

The photosensitive member 11 rotates in a clockwise direction in the example of FIG. 1 and the side surface 11b is charged by the charging device 12. The charged side surface 11b is exposed to the light emitted by the print head 13 so that the electrostatic latent image to be developed is formed corresponding to image.

Self-light-emitting type devices, such as light emitting diodes (LEDs) or electroluminescences (ELs), are used widely in the print head. However, such devices may be replaced by a liquid crystal device that selectively transmit light from a separately provided light source. In this embodiment, LEDs are used.

The print head 13 comprises an LED board 23 and a lens array 24. A rectangular LED array chip 20 including a plurality of LEDs 20a and a plurality of driver chips 21 for driving the respective LEDs 20a is mounted on a board 22 of the LED board 23. The lens array 24 comprises a plurality of self-image-formation type lenses 24a for projecting the exposure light from the LED board 23 onto the photosensitive member 11.

A plurality of LEDs 20a are arranged on the LED array chip 20 in the longitudinal direction or main scanning direction along the rotation axis 11a of the photo-sensitive member 11. Six hundreds (600) per inch of the LEDs 20a are provided on the LED array chip 20 for the image forming apparatus 10 having a resolution of 600 dpi (dots per inch).

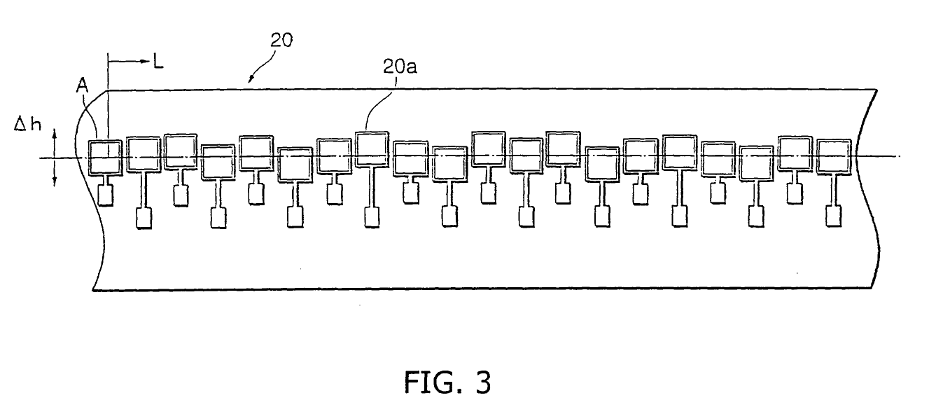

FIG. 3 shows the arrangement of the LEDs 20a on the LED array chip 20, which shows the characteristics of the present invention. That is, the respective adjacent LEDs 20a are disposed in a stepped-fashion in a sub-scanning direction which is perpendicular to the main scanning direction.

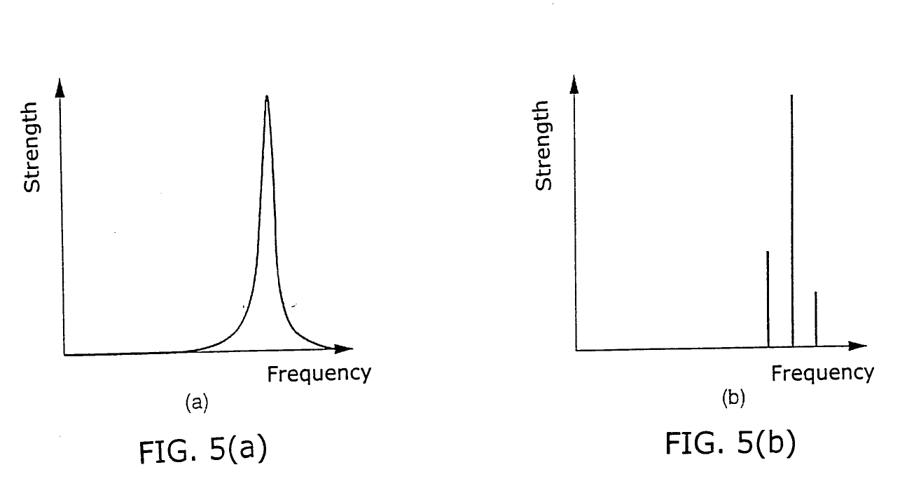

The degree of the stepped-fashion is determined according to the below-mentioned noise having the frequency characteristics shown in FIG. 5(a) or 5(b).

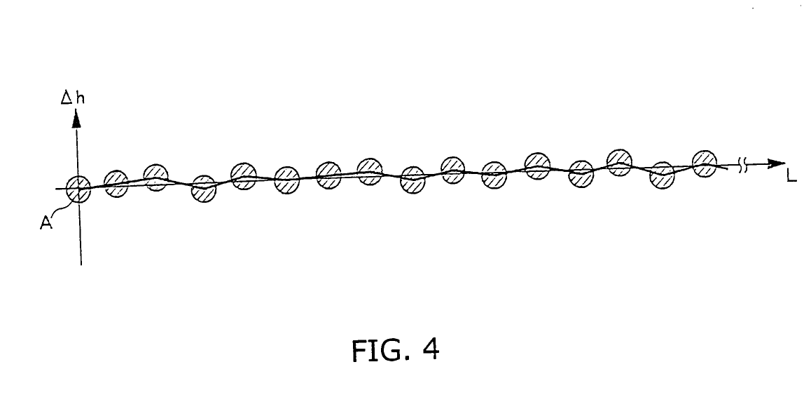

In FIG. 3, the respective LEDs 20a are arranged on the LED array chip 20 such that the LEDs 20a other than the reference LED 20a at a position A have such noise characteristics as stated above. The relationship between a distance L, which is a distance from the position A of the reference LED 20a to the other LEDs 20a in the main scanning direction or longitudinal direction of the LED array chip 20, and a positioning difference Δh from the position A in the sub-scanning direction, is shown in FIG. 4. As shown in FIG. 4, the positioning difference Δh has discrete values corresponding to the distance L. A row of sampled values or the respective discrete values is subject to discrete Fourier transformation to provide the frequency characteristics of the arrangement of LEDs 20a. According to the embodiment, the respective LEDs 20a are arranged such that the frequency characteristics thereof are consistent with the noise frequency characteristics shown in FIG. 5(a) or 5(b).

It is well known that the human eyes are hardly sensitive to high frequencies above a specific spatial frequency. There is a blue noise in such a high-frequency region, which has the frequency characteristics of a certain frequency band width. The characteristics of the blue noise are shown in FIG. 5(a). The above-mentioned step provided between the respective LEDs 20a is determined according to the blue noise which has the frequency characteristics in the high-frequency region where the human eyes are not sensitive.

Alternatively, a line spectrum noise, which has a specific frequency component in the high-frequency region and the frequency characteristic shown in FIG. 5(b), may be used for the blue noise. The line spectrum noise having three specific frequency components is shown in FIG. 5(b).

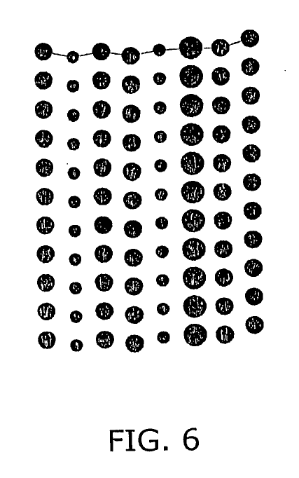

In FIG. 6, since the respective LEDs 20a are arranged in the stepped-fashion according to the embodiment, the respective dots I each row in the horizontal direction of the output pattern have steps corresponding to the arrangement of the LEDs 20a. However, the respective dots in each column in the vertical direction are positioned in a straight line without any step or fluctuation.

The linear pattern of the vertical dots is easy for the human eyes to catch because it has strong directivity. When the fluctuated pattern of the horizontal dot groups is added, the human eyes are drawn to the horizontal direction as well as the vertical direction.

Consequently, even when different dot sizes appear in the adjacent vertical dot groups because of the different luminous energies of the respective LEDs 20a, it is possible to reduce the visible difference of the image density caused by the different dot sizes because the human eyes are attracted in two directions. For example, although the dot sizes in the third and fourth columns in the output pattern in FIG. 6 are very different, the difference in the image density between the two columns becomes less remarkable when the whole output pattern is seen from far away.

It is concerned that the developed image is disarrayed because of the steps in each row as shown in FIG. 6. However, the horizontal disarray has no visible influence since the well known half-tone treatment has been performed prior to the exposure process by an image treatment apparatus (not shown) using a screen having a resolution lower than the above-mentioned step.

As described above, the image forming apparatus 10 comprises the LEDs 20a on the LED array chip 20, which are arranged in the stepped-fashion determined according to a high-frequency noise, such as the blue noise, so that the output pattern appears in the stepped-fashion in the horizontal direction. Consequently, according to the image forming apparatus 10 in the first embodiment, the human eyes are directed in two dimensions so that it is possible to reduce the visible difference in the image density in the vertical direction caused by the different luminous energies of the respective LEDs 20a.

As shown in FIG. 3, the adjacent LEDs 20a are arranged in a stepped-fashion according to this embodiment. However, the stepped-fashion is not limited to the example in FIG. 3, as far as the step is determined according to the above-mentioned high-frequency noise. For example, a step may be provided between pairs of the LEDs 20a or a step may be provided between a pair of the LEDs 20a and a single LED 20a arranged between two pairs of the LEDs 20a.

The image forming apparatus 10 according to the embodiment includes a copying machine, printer, and facsimile machine using the electro-photographic system.

(Second Embodiment)

In the first embodiment, a plurality of the LEDs 20a are arranged in the stepped-fashion. The stepped output pattern is effected by another way. For example, if a plurality of LEDs 20a are arranged linearly and such a mechanism is provided as to make the respective LEDs 20a emit light at a predetermined individual timing, not at the same timing, the stepped output pattern is provided.

An image forming apparatus 50 in the second embodiment comprises an identical structure to that of the first embodiment except for an image forming apparatus 10 and a print head 53.

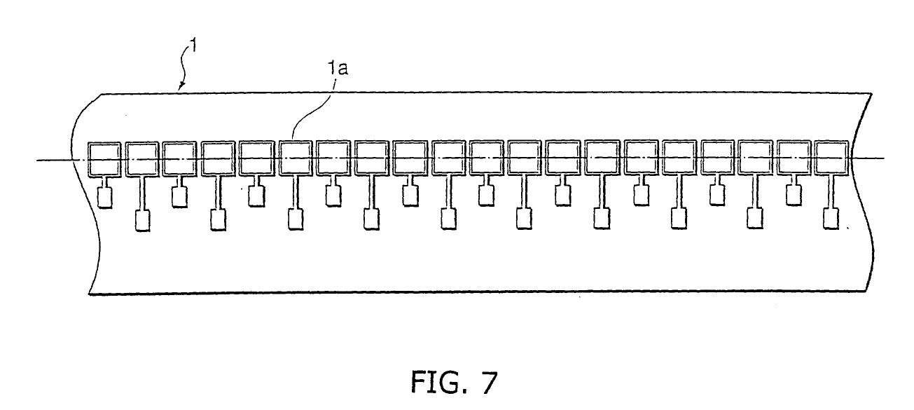

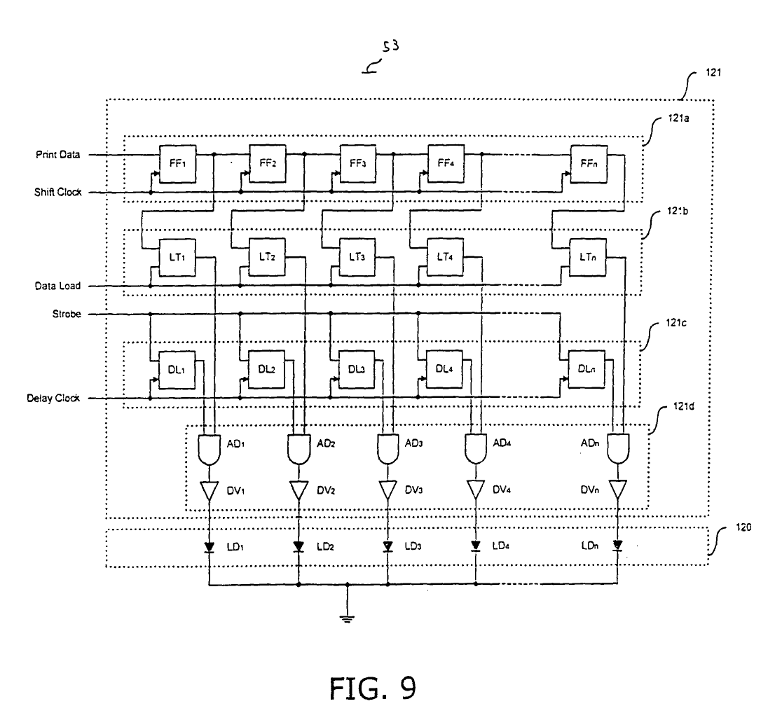

FIG. 9 shows the construction of the print head 53 of the image forming apparatus 50 according to the second embodiment. The LEDs used in the print head 53 are arranged in the same way as in the conventional print head shown in FIG. 7, that is, the LEDs are not stepped in the sub-scanning direction.

In FIG. 9, the print head 53 is composed of a plurality of light emitting devices or an LED array 120, and a drive circuit or driver chip 121.

The driver chip 121 consists of a shift register 121a, a latch 121b, a delay section 121c, and a drive section 121d, which are provided such that each component of them corresponds to each LED (LD1, LD2, . . . , LDₙ) of the LED array 120.

The shift register 121a is composed of a plurality of flip-flops (FF1, FF2, . . . , FFₙ), stores inputted exposure data, and shifts in sequence according to a shift clock.

The latch 121b is composed of a plurality of memories (LT1, LT2, . . . , LTₙ), and inputs and stores the exposure data in the corresponding flip-flops of the shift register 121a according to an inputted data load signal.

The delay section 121c is composed of a plurality of delay circuits (DL1, DL2, . . . , DLₙ), inputs a strobe signal, which is a timing signal for the exposure, delays the strobe signal according to the amount of delay memorized therein in advance, and outputs the delayed strobe signal.

The drive section 121d is composed of a plurality of ANSD gates (AD1, AD2, . . . , ADₙ) and a plurality of drivers (DV1, DV2, . . . , DVₙ).

Only LD1 of the LED array 121 will be described below to simplify the description of the operation of the driver chip 121.

The exposure data stored in the flip-flop FF1 of the shift register 121a is inputted into and stored in the corresponding memory LT1 of the latch 121b according to the data load signal.

When the strobe or a timing signal for the exposure is inputted into the delay circuit DL1 of the delay section 121c, it is delayed by a period of time corresponding to the amount of delay (e.g., the number of count of a delay clock) memorized in advance in the delay circuit DL1. Then, the delayed strobe signal is outputted.

The AND gate AD1 of the drive section 121d receives the output from the memory LT1 and the output from the delay circuit DL1 and outputs the logic product of the two outputs into the driver DV1.

The drive DV1 drives the corresponding LED LD1 according to the output from the AND gate AD1.

If the amounts of delays stored in the delay circuits DL1 and DL2 of the delay section 121c are different, the corresponding LEDs LD1 and LD2 emit lights at different timings. As shown in FIG. 1, the photo-sensitive member 11 rotates with respect to the LED array 120 including the LEDs LD1 and LD2. Consequently, the different timings of lights emitted from the LEDs LD1 and LD2 make the exposed points on the photo-sensitive member 11 shift in the sub-scanning direction. Accordingly, the stepped image is formed on the photo-sensitive member 11 in the same way as the first embodiment.

As described above, even when the LED array including no stepped LEDs is used, it is possible to reduce the visible difference in the image density by making different from each other the amounts of delays memorized in the respective delay circuits of the delay section 121c.

In the print head and image forming apparatus according to the invention, a plurality of light emitting devices are arranged such that the adjacent light emitting devices are stepped from each other in the rotation direction of the photo-sensitive member, or a plurality of light emitting devices disposed linearly emit light at different timings each other by employing a delay mechanism. Consequently, it is possible to provide the output pattern capable of directing the human eyes in two dimensions, thus reducing the visible difference in the image density.

1. A print head comprising:
a plurality of light emitting devices disposed at such positions as to make exposure at substantially equal intervals in a first direction, adjacent devices of said light emitting devices being shifted from each other in a second direction perpendicular to said first direction; and
a plurality of drive circuits each driving corresponding one of said light emitting devices.

2. The print head according to claim 1, wherein said adjacent devices are disposed in a stepped fashion in said second direction.

3. The print head according to claim 2, wherein an extent of said stepped-fashion is determined such that said stepped-fashion provides spatial frequency characteristics exceeding a specific spatial frequency, wherein said spatial frequency characteristics are determined by distances in said first direction between one of said light emitting device and the others of said light emitting devices and positioning differences in said second direction between said one of said light emitting devices and said others of said light emitting devices.

4. The print head according to claim 3, wherein said spatial frequency characteristics have a predetermined frequency band width.

5. The print head according to claim 4, wherein said spatial frequency characteristics have characteristics of a blue noise.

6. The print head according to claim 3, wherein said spatial frequency characteristics have characteristics of a line spectrum noise indicating specific spatial frequencies.

7. The print head according to claim 1, which further comprises:
a plurality of memories each storing a delayed time of corresponding one of said light emitting devices with respect to a reference light-emitting signal; and
a plurality of delaying means each delaying said reference light-emitting signal according to said delayed time stored in corresponding one of said memories, wherein each of said drive circuits drives said corresponding one of said light emitting devices according to said reference light-emitting signal delayed by said corresponding one of said delaying means.

8. The print head according to claim 7, wherein said delayed time stored by each of said memories is determined for every one of light emitting devices with predetermined distribution characteristics.

9. An image forming apparatus comprising:
a photosensitive member; and
a print head including a plurality of light emitting devices for emitting light to said photosensitive member so as to form an electrostatic latent image on said photosensitive member in a main scanning direction, wherein each of said light emitting devices is arranged in a stepped-fashion with respect to each other in a sub-scanning direction perpendicular to said main scanning direction.

10. An image forming apparatus comprising:
the print head according to claim 8;
a photosensitive member of which a surface is movable in said second direction with respect to said print head; and
an image forming section for forming an image according to said electrostatic latent image formed on said surface of said photosensitive member.
